(19) United States
(12) Patent Application Publication
(10) Pub. No.: US 2008/0035878 A1
(43) Pub. Date: Feb. 14, 2008

(54) Valve for actuating a clutch of a motor vehicle transmission

(75) Inventors: Reinhard Stehr, Buhl (DE); Manfred Homm, Buhl-Neusatz (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/891,643

(22) Filed: Aug. 10, 2007

Related U.S. Application Data
(63) Continuation of application No. PCT/DE06/00059, filed on Jan. 18, 2006.

(30) Foreign Application Priority Data
Feb. 11, 2005 (DE) 10 2005 006 196.6

(51) Int. Cl. F16K 25/00

(52) U.S. Cl. 251/368

(57) ABSTRACT

A valve for controlling a clutch in a motor vehicle transmission. The valve includes a control spool that is movably received in a bore of a valve housing to control hydraulic flow to and from control channels in the housing and that open into the bore. The control spool is provided with a coating that includes at least one metal of the eighth sub-group and with a non-metal of the fifth main group of the periodic table.

### CROSS-REFERENCE TO RELATED APPLICATION

This is a continuation of International Application Serial No. PCT/DE2006/000059, with an international filing date of Jan. 18, 2006, and designating the United States, the entire contents of which is hereby incorporated by reference to the same extent as if fully rewritten.

### BACKGROUND OF THE INVENTION

1. Field of the Invention

The present invention relates to a valve for actuating a clutch of a motor vehicle transmission. The valve includes a control spool that is movable in a valve housing bore and controls at least one control channel.

2. Description of the Related Art

The use of such valves, in particular of hydraulic valves, is known in the automotive engineering field. For example, the known valves are used for hydraulically controlling clutches of automatic transmissions. Normally the valve housing and also the control spool are made of aluminum. To achieve wear protection for the housing bore and for the control spool which is guided in it, the surface of the control spool is hardened. It is known to harden the surface of the control spool by hard anodizing.

The known valves, with hard anodized control spools, are normally movably received in a bore in a die cast aluminum valve housing, in order to control different control channels by corresponding spool movements. Such a valve housing can also be referred to as an aluminum control spool case.

It has been found that increased wear occurs, particularly in the die cast housing bore in the vicinity of the control channels. That wear impairs the functioning and the service life of the valves. In particular, it has also been found that due to the constant motion of the control spool, shoulders occur along the wall of the bore, which impede free motion of the control spool in at least in some places and restrict the hydraulic transmission performance of the valve. In addition, the wear results in increased leakage and hence to performance losses.

Accordingly, an object of the present invention is to provide a valve of the type described above that can be further improved with regard to its performance capability and service life.

### SUMMARY OF THE INVENTION

The object is achieved by a valve in accordance with the present invention for actuating a clutch of a motor vehicle transmission and having a control spool that is movable in a housing bore and that controls at least one control channel. The control spool is provided with at least one coating which contains at least one metal of the eighth sub-group and one nonmetal of the fifth main group of the periodic system. In that way it is possible to realize especially effective wear protection between the housing bore and the control spool, so that overall the service life of the valve in accordance with the present invention is increased. The coating can particularly protect the heavy demand areas of the control spool and of the wall of the bore against wear in such a way that high demands on the hydraulic fluid transmitting performance of the valve are also ensured.

Thus, the valve provided for clutch actuation preferably can convert an applied pilot pressure of an electromagnetic actuator nearly unchanged into a clutch pressure proportional to the pilot pressure. Because of the loss-free motion, the control spool can be in constant equilibrium between two pressures acting on respective piston surfaces of the spool, with it being possible to set a desired clutch pressure through the movements of the control spool in that force equilibrium in cooperation with the corresponding control channels or control edges. In the case of the valve in accordance with the invention, that can be realized without the disturbing frictional forces or other interfering forces between the bore surface and the control spool.

It has been found that in particular a compound of a metal of the indicated sub-group and of a non-metal of the indicated main group has especially advantageous properties for achieving optimal wear protection for the control spool. Other metals, such as iron and/or cobalt, for example, can also be used as the coating material. Furthermore, it is also possible to use another non-metal, such as, for example, nitrogen, or the like, for the coating.

Preferably, a nickel-phosphorus compound can be employed as the coating. It has been found that the control piston or control spool coated with a chemically deposited nickel compound (such as Durni-Coat®) protects a bore wall in the valve housing made in particular from aluminum against wear. That is because a nickel-phosphorus compound on the control spool interacting with a bore of a housing made from aluminum represents an especially low coefficient of friction, which does not result in any manifestations of corrosion in the valve. In addition, the chosen coating can protect the basic material of the control spool against the embedding of hard dirt particles.

That is especially true if a heat treatment is advantageously performed on the coating, because the hardness of the described coating can be further increased by heat treating. In addition, the adhesion of the coating to the base material can be improved.

Furthermore, the reduction of wear in the valve in accordance with the invention also keeps leakage down over the life of the valve, and thereby improves the overall efficiency of the system.

One possible embodiment of the present invention can provide for the valve to be used as a hydraulic valve for controlling a continuously variable transmission (CVT). The coated control spool can also be employed for volume flow regulating valves, for example in the field of vehicle transmissions. Because of the high power throughput, those valves are subjected to special loads, and they tend to suffer especially high bore wear. Here too, the coating of the control spool proposed in accordance with the invention, in addition to reducing wear, can also protect the control spool against erosion

Another embodiment of the present invention can provide for the valve in accordance with the invention to be constructed as a pressure limiting valve. For example, the pressure limiting valve can be employed to produce a system pressure in a controller for an automatic vehicle transmission. In that exemplary embodiment also, special wear protection is advantageous due to especially high power throughput.

### BRIEF DESCRIPTION OF THE DRAWING

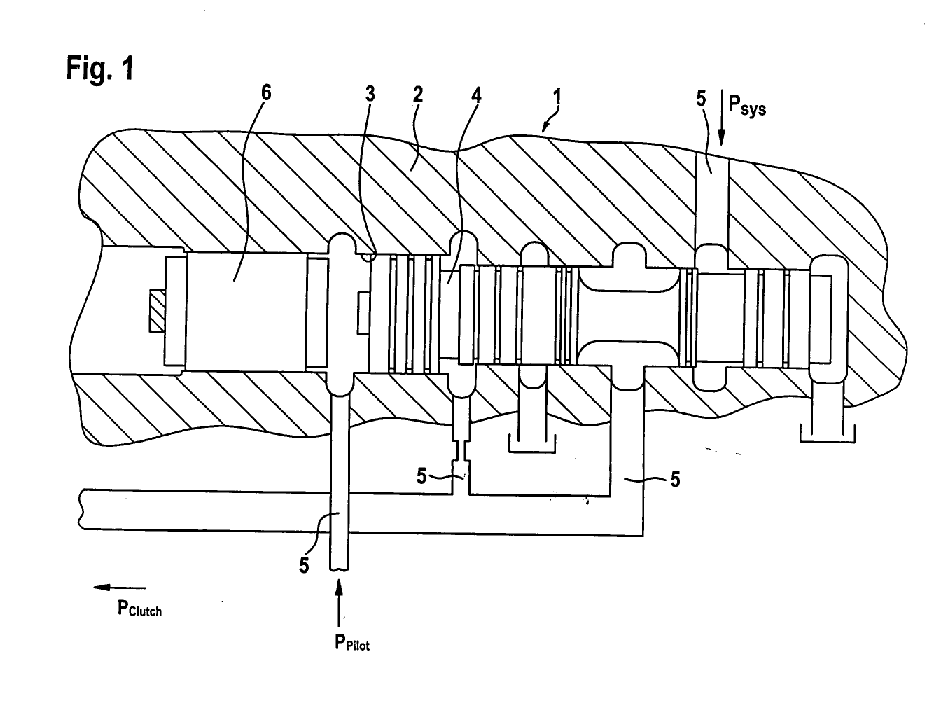

The present invention will be explained in greater detail below on the basis of the drawing. FIG. 1 shows an exemplary embodiment of a hydraulic valve in accordance with the present invention for actuating a clutch of a motor vehicle transmission.

### DESCRIPTION OF THE PREFERRED EMBODIMENTS

As shown in FIG. 1, hydraulic valve 1, which is only partially shown, includes a valve housing 2 in which a bore 3 is provided in the form of a recess in the housing, in which a movable control piston 4 is guided as a control spool. The bore 3 is closed at one end by a sealing plug 6. Opening into bore 3 are a number of control channels 5, which are controlled by control piston 4 moving in bore 3 and are under a certain pressure.

To that end, control piston 4 is in constant equilibrium between a pilot pressure Pₚᵢₗₒₜ and a clutch pressure P_{clutch} which is proportional to the pilot pressure Pₚᵢₗₒₜ. The two pressures act on respective piston surfaces of control piston 4 in such a way that the motion of control piston 4 causes an interaction of the control edges of control piston 4 and the openings of corresponding control channels 5 to be realized, in order to set a desired clutch pressure P_{clutch}. Since the manner of function of such a hydraulic valve 1 is known, it will not be described further here.

To keep the wear between control piston 4 and the wall of bore 3 to the minimum possible, in the depicted hydraulic valve 1 in accordance with the invention a coating of the surface of control piston 4 is provided. Here control piston 4 is coated with a chemically precipitated nickel-phosphorus compound (for example, Durni-coat®). Other compounds are also conceivable as the coating. It has been found, however, that a coating on control piston 4 of a nickel-phosphorous layer especially reduces the wear between control piston 4 and bore 3, and thus increases the overall service life and the performance capacity of hydraulic valve 1.

1. A valve for actuating a clutch of a motor vehicle transmission of a vehicle, said valve comprising: a housing having a bore;
a control spool that is movable in the bore and that controls at least one control channel, wherein the control spool has at least one coating that includes at least one metal of the eighth sub-group and one non-metal of the fifth main group of the periodic system.

2. A valve in accordance with claim 1, wherein a nickel-phosphorus compound is included as the at least one coating of the control spool.

3. A valve in accordance with claim 1, wherein the at least one coating is heat treated.

4. A valve in accordance with claim 1, wherein the valve is a hydraulic valve for controlling a continuously variable transmission (CVT).

5. A valve in accordance with claim 1, wherein the valve is a volume flow regulating valve.

6. A valve in accordance with claim 1, wherein the valve is a pressure limiting valve.
